(19) United States
(12) Patent Application Publication
(10) Pub. No.: US 2012/0286485 A1
(43) Pub. Date: Nov. 15, 2012

(54) CART FOR LARGE AREA OBJECTS

(76) Inventors: Paul Giampavolo, Newton, NJ (US); Christopher M. Johnson, Glen Allen, VA (US)

(21) Appl. No.: 13/418,794

(22) Filed: Mar. 13, 2012

Related U.S. Application Data
(63) Continuation-in-part of application No. 29/391,461, filed on May 9, 2011, now Pat. No. D655880.

(51) Int. Cl. B62B 5/00; B62B 3/14

(52) U.S. Cl. 280/33.992

(57) ABSTRACT

A cart for transporting large area objects provides a region that can support objects that have a large height and width relative to depth dimension, while accommodating more conventionally sized and shaped objects, such as might be found in a retail environment. A central leg divides the payload area of the cart into a large area object carrying portion and a region that is larger in dimension than the large area object region. The central leg is set back from a front edge of the cart, and includes a slanted upper portion to avoid interference with components of other like carts to permit the like carts to be nested. The cart permits relatively large area objects to be transported with relative ease, in addition to conventionally sized and shaped objects.

### CROSS-REFERENCE TO RELATED APPLICATIONS

This is a continuation-in-part application of application Ser. No. 29/391,461, filed May 9, 2011, the entire disclosure of which is hereby incorporated herein by reference.

### STATEMENT REGARDING FEDERALLY SPONSORED RESEARCH OR DEVELOPMENT

(Not Applicable)

### BACKGROUND OF THE INVENTION

The present disclosure relates generally to carts for transporting objects, and more particularly to carts for transporting objects that include at least one side with a relatively large surface area.

The retail environment has undergone a number of changes in recent years, which tend to change a shopping customer's experience. For example, club or warehouse type shopping venues typically permit customers to obtain items in bulk with a corresponding decrease in relative costs of items. The items in bulk are typically selected by the customer and transported using carts that are configured to permit relatively large items to be placed on the cart for ease of transport by the customer. The type of carts used in these types of shopping venues often have a large open area with a rack support for accepting the relatively large packages of the products in bulk.

Other known shopping venues, such as hardware or furniture stores may provide carts for transporting a relatively few large items that may each represent a single product. The types of carts used tend to be open with a support rack, and can typically withstand a significant amount of loading.

In each of the above described carts, a large area object may be easily carried on the cart, however, it may sometimes be difficult to place other items on the cart when it is loaded with a large area object. In some cases, a relatively thin large area object may be somewhat delicate or fragile, so that stacking items on the large area of the object can lead to damage of the packaging or object itself. It may be possible to rearrange the items on the cart so that the large area object can be placed atop the other items, however, such a practice is cumbersome to the customer, and can lead to unstable situations for transporting a large area object, which again may lead to accidental damage to the packaging or object itself.

Some multipurpose carts are available that can carry multiple, different sized items with relative ease and security, such as by implementing different size baskets or cart frame sections that are conducive to holding objects of certain sizes, either in a stacked configuration or upon a frame structure that is suitable for transporting different sized objects. For example, carts used in lumberyards or associated hardware stores can often accommodate different shaped objects such as pieces of lumber that have a significantly greater length dimension compared to other dimensions, while also accommodating relatively large surface area items such as pieces of sheetrock or plywood, which can have an area dimension of 8 feet by 4 feet, for example. The objects with relatively large surface area are typically placed on the cart in a vertical orientation, between frame structures that tend to support the large area object in an upright position. Typically, these types of carts tend to be rugged and built to withstand relatively heavy loading, and as such are not as easy to maneuver in a retail setting. In addition, these types of carts typically do not have baskets or containers for holding smaller items. Accordingly, a customer seeking to transport a large area object together with typically smaller general merchandise would choose between a heavy duty cart for transporting large area objects that are somewhat unwieldy and typically does not secure smaller merchandise, or may choose a cart that generally secures smaller merchandise, but typically does not permit large area objects to be held securely.

In addition, the heavy duty carts typically used for transporting lumber are not nestable, so that they tend to take up greater space in a retail environment. In addition, these types of non-nestable carts are unable to be grouped together to manage a number of carts at once, so that it is more difficult for a retailer to manage such carts.

### BRIEF SUMMARY OF THE INVENTION

In accordance with the present disclosure, a nestable cart is provided for transporting large area objects. The cart includes a partition and support within which a large area object can be accommodated. The partition is arranged to permit other various other objects, typically with smaller main surface areas in relation to an object with a large main surface area. The support provided for a large area object can also act as the partition, and is configured to permit the cart to be nestable with other like carts.

According to an aspect of the disclosure, the cart includes a tubular frame to which wheels can be mounted. The wheels can be arranged such that one or more front wheels can swivel, or one or more back wheels can swivel, to permit the cart to be maneuvered or navigated through a turn.

According to another aspect of the present disclosure, the cart includes a partition member arranged in a central region of the cart that can function as a divider between a region of the cart that can accommodate large area objects, and a region of the cart that can accommodate more general sized objects. The partition member can be a tubular member, and can act as a support for one or more large area objects located in the large area object partition, or general objects located in the general object area. The partition member can be connected to the frame, and project from an upper rear area of the cart frame to a forward lower area of the cart frame, to permit the partition member to act as a divider between the large area object region and general size object region.

According to another aspect of the present disclosure, a wireframe rack is provided on a lower portion of the cart, in a pivoting relationship with the cart frame. The wireframe rack is arranged to pivot in an upward direction when another like cart is nested with the cart of the present disclosure. The partition member can be arranged to be connected to the cart frame to avoid interfering with the pivoting movement of the wireframe rack to avoid interference with a nesting operation.

According to another aspect of the present disclosure, the cart includes a crossbar frame member to which the petition member can be attached. The crossbar frame member is located in an upper rear region of the cart, and extends rearward as well as across the width of the cart. The partition member can be attached to the crossbar frame member at a rearward location, such that a portion of the crossbar frame member and the partition member form a portion of a perimeter of the large area object region of the cart. The crossbar frame member and the partition member can provide support for a large area object located in the large area object region partially defined by the crossbar frame member and the partition member. The crossbar frame member is located and sized to avoid interference with a nesting operation of like carts, while contributing to defining a large area object region.

According to another aspect of the present disclosure, the cart is provided with hook brackets that can support other object carriers or partitions, including wireframe baskets, handled shopping bags, or other containers that can hold and support objects on the cart. The hook brackets can be located on the partition member, the crossbar frame member, or other parts of the shopping cart frame, including a push-handle.

### BRIEF DESCRIPTION OF THE SEVERAL VIEWS OF THE DRAWINGS

The present disclosure is described in greater detail below, with reference to the accompanying drawings, of which:

FIG. 1 is a right side elevation view of a cart for large area objects in accordance with an exemplary embodiment of the present disclosure;

FIG. 2 is a left side elevation view of the embodiment of FIG. 1;

FIG. 3 is a rear elevation view of the embodiment of FIG. 1;

FIG. 4 is a front elevation view of the embodiment of FIG. 1;

FIG. 5 is a top plan view of the embodiment of FIG. 1;

FIG. 6 is a bottom plan view of the embodiment of FIG. 1;

FIG. 7 is a rear perspective view of the embodiment of FIG. 1;

FIG. 8 is a front perspective view of the embodiment of FIG. 1;

FIG. 9 is a front perspective view of an exemplary embodiment of a cart is accordance with the present disclosure, showing the arrangement of a large area object and handled shopping bag on the cart; and

FIG. 10 is a side elevation view of another exemplary embodiment of the present disclosure, showing nesting of multiple carts.

### DETAILED DESCRIPTION OF THE INVENTION

This application is a continuation-in-part application of application Ser. No. 29/391,461, filed May 9, 2011, the entire contents of which are hereby incorporated herein by reference.

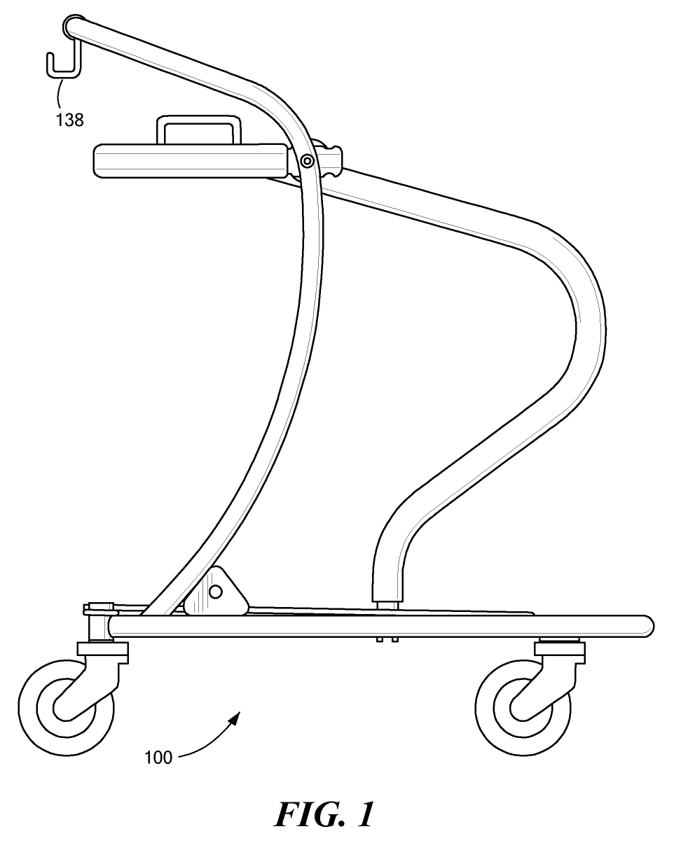

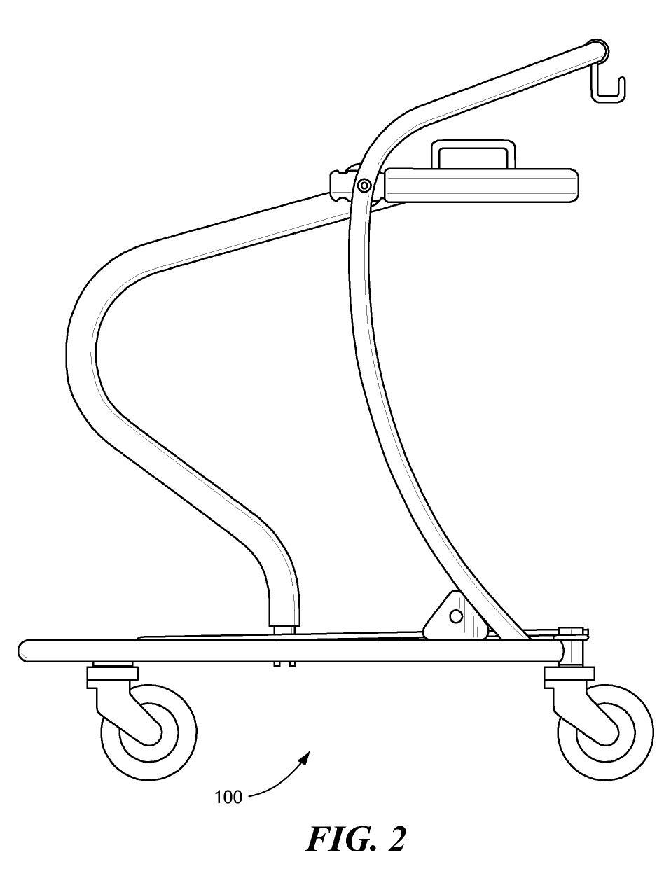

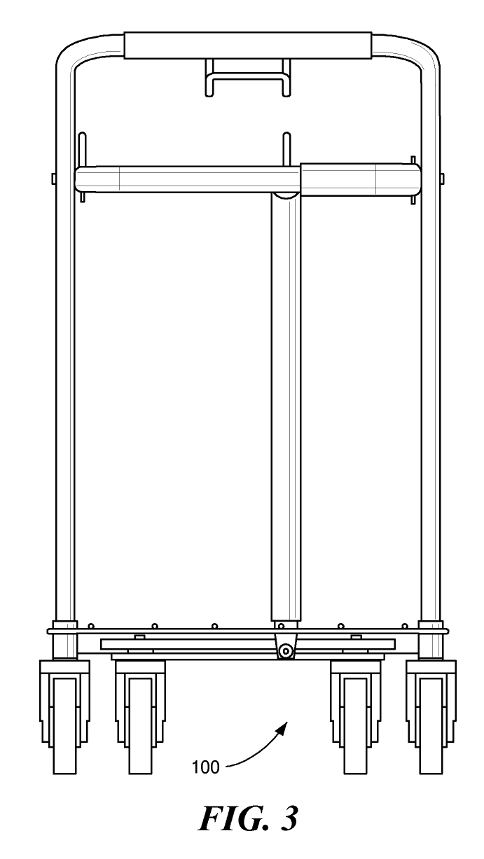

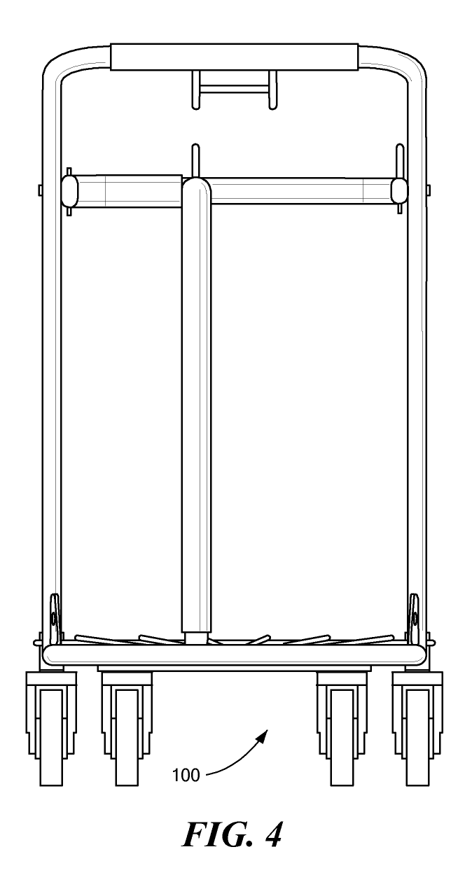

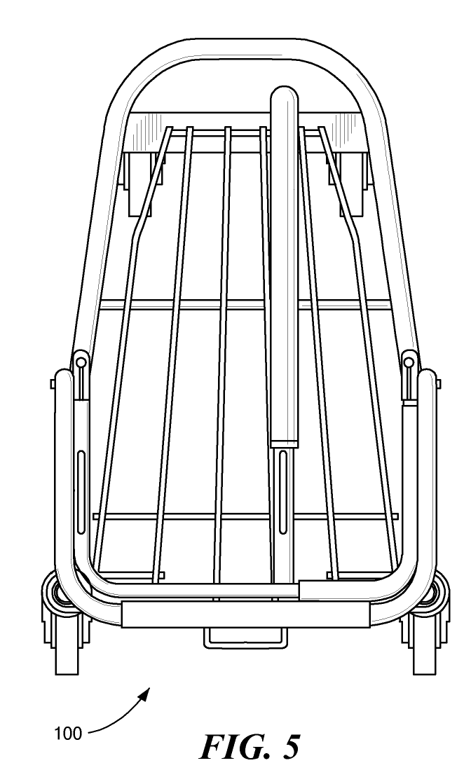

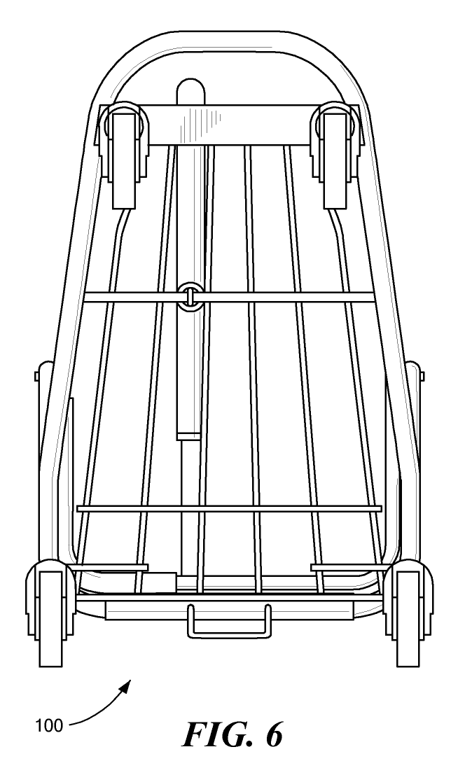

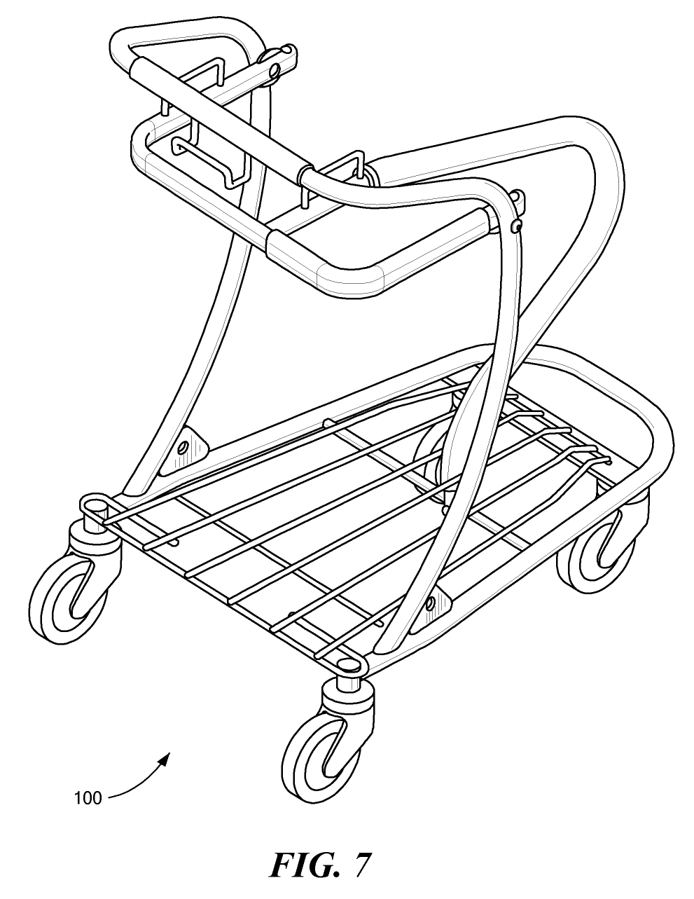

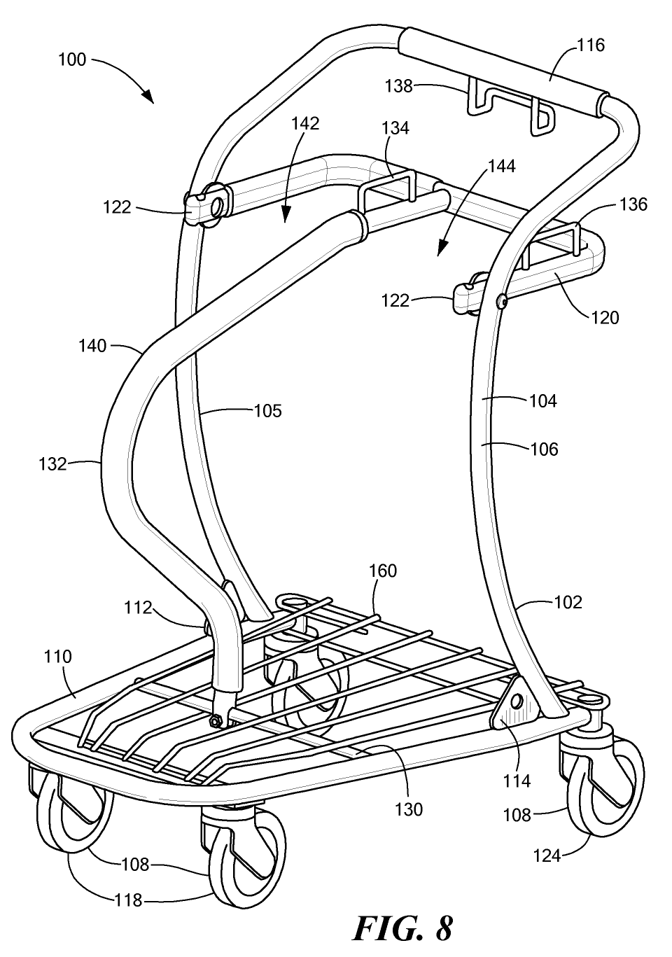

Referring to FIGS. 1-8, a cart 100 according to an exemplary embodiment of the present disclosure is illustrated in various views. With reference to the perspective view of cart 100 illustrated in FIG. 8, the features and advantages of this exemplary embodiment of the present disclosure are readily viewed.

Cart 100 includes a tubular frame 102 that includes an upright portion 104 with two legs 105, 106 that are generally formed as posts. Legs 105, 106 are attached to a lower frame 110. Reinforcing brackets 112, 114 are attached to lower frame 110 and legs 105, 106 to contribute to maintaining a physical relationship between upright portion 104 and lower frame 110. Brackets 112, 114 help to absorb strain or loading that may occur from a person pushing cart 100 at a push-handle portion 116 of upright portion 104. Cart 100 includes casters or wheels 108 mounted to lower frame 110. Wheels 108 can be arranged such that one or more front wheels 118 can swivel or be fixed in orientation, and/or one or more back wheels 124 can swivel or be fixed in orientation, to permit cart 100 to be maneuvered or navigated through a turn.

Cart 100 includes a wireframe rack 160 that is provided to lower frame 110. Rack 160 can be coupled to a front region of lower frame 110 with a hinge (not shown) to permit pivotal movement with respect to lower frame 110. Rack 160 is arranged to permit a rear portion to pivot in an upward direction when another like cart 100 is nested, or horizontally stacked, with cart 100 of the present disclosure.

Tubular frame 102 also includes a rear support member 120 that has ends 122 that are respectively attached to legs 105, 106. Member 120 is generally arranged to extend in a horizontal direction, toward a rear of cart 100 from ends 122 that are attached to legs 105, 106. Member 120 can be used to define a rear extent for loading objects on cart 100. According to an exemplary embodiment, member 120 extends rearward a distance that is less than the distance push-handle 116 extends rearward, to permit a gap to remain between push-handle 116 and member 120 in a horizontal direction. The gap between member 120 and push-handle 116, in a horizontal direction, permits a user of cart 100 to grasp push-handle 116 without interference from items that may be loaded onto cart 100 that can be placed to abut an interior portion of a rearward extent of member 120.

Cart 100 also includes a middle leg 140 that is connected between member 120 and a crossbar 130 that is connected to lower frame 110. Crossbar 130 acts as a support for leg 140, and is supported in turn by connections to lower frame 110. Crossbar 130 can be a tubular member, or a solid bar, and is illustrated as being connected with leg 140 with a bolt and nut. Leg 140 may also be composed of a tubular member, and is connected to member 120 by being welded, or inserted into an opening in member 120 and fastened to member 120 at the opening. Leg 140 is thus supported by crossbar 130 and member 120 and arranged to be free of rack 160 to avoid interfering with the pivoting movement of rack 160 to avoid interference with a nesting operation.

According to an exemplary embodiment, leg 140 is arranged on cart 100 to be offset laterally from a central midline of cart 100 that divides cart 100 into a left and right portion, viewed from a rear of cart 100. Thus, leg 140 can be arranged to be connected to crossbar 130 and member 120 at locations to permit leg 140 to be located entirely in a right hand half of cart 100, as viewed from the rear. Such a position of leg 140 provides a smaller dimensional area 142 defined by leg 140, member 120 and leg 105, and a larger dimensional area 144 defined by leg 140, member 120 and leg 106. Smaller dimensional area 142 can thus accommodate objects that have a relatively large surface area compared to their thickness or depth, while larger dimensional area 144 provides a generally larger region that can accommodate more conventionally sized objects. The provision of leg 140, offset from a central midline of cart 100, thus provides an accommodation for retaining large area objects in dimensional area 142, while permitting more conventionally sized and shaped objects, i.e., objects with two or more of a height, width or depth that are relatively similar in size, to be stored and transported in larger dimensional area 144.

According to various exemplary embodiments, cart 100 includes various features that may be incorporated to assist with the transport of large area objects and more conventionally sized objects. For example, cart 100 may include a sleeve 132 on leg 140 to act as a protective bumper for objects placed on and transported by cart 100. Sleeve 132 may be composed of a foam rubber or other soft or resilient material that can act as a cushion for objects placed on cart 100 that come into contact with leg 140.

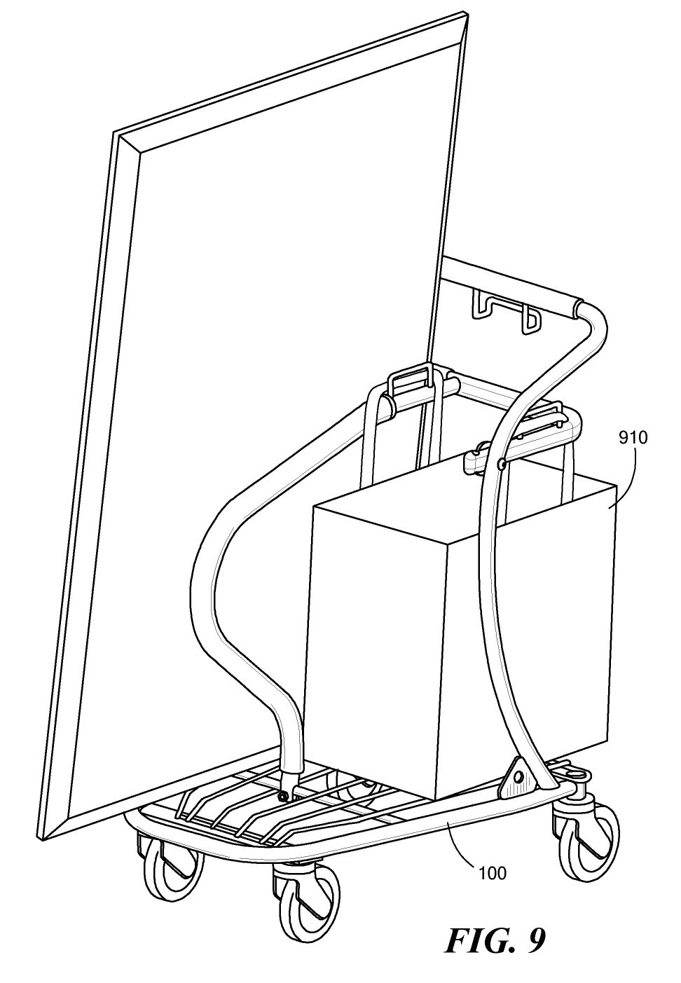

Leg 140, as well as member 120, may also include brackets 134, 136, respectively, which can be used to support a handled container, such as container 910 shown in FIG. 9. Brackets 134, 136 can be used to support the handles of such a container 910 by being directed upward and being located at a relatively similar height on cart 100. As illustrated in FIG. 8, brackets 134, 136 can be spaced apart from each other to contribute to maintaining container 910 (FIG. 9) in an open position to accept merchandise selected by the user/shopper.

According to an exemplary embodiment, cart 100 may feature a hook bracket 138 that is positioned on upright portion 104 near push-handle 116, and is sized and shaped to accept a handle of a container to permit the container to hang from hook bracket 138. Hook bracket 138 is thus formed in the shape of a “J” as viewed from a side elevation, such as is shown in FIG. 1. The shape and arrangement of hook bracket 138 can retain the handle of a handled container (not shown) for ease of use by a user/shopper, who can place selected merchandise in such a container while shopping. The location of hook bracket 138 permits a container to be hung at a rear of cart 100, without interfering with large area objects that may be located in smaller dimensional area 142.

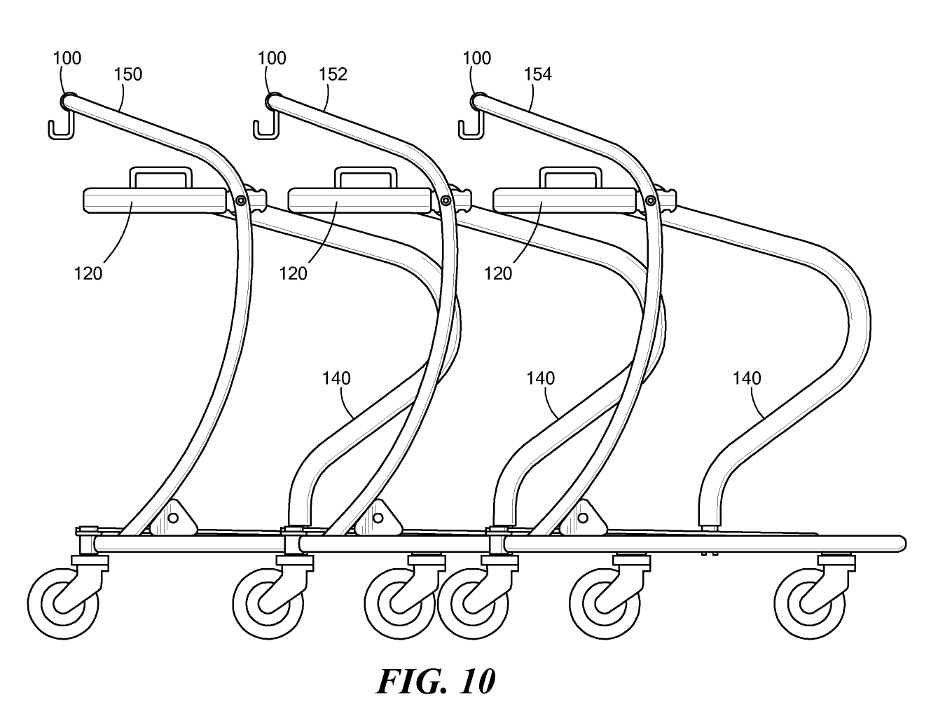

Referring now to FIG. 10, a number of carts 100 are shown in a nested configuration, which permits storage of carts 100 in a reduced size area. Nested carts 100 are designated as middle nested cart 152, and referring to locations relative to middle nested cart 152, rearward nested cart 150 and forward nested cart 154, for ease of reference and description purposes. Each of carts 100 in FIG. 10 include leg 140 that is arranged and shaped to permit carts 100 to be nested together. For example, leg 140 is connected to crossbar 130 near lower frame 100 at a setback location from a front edge of cart 100. The setback of the attachment point of leg 140 near lower frame 110 permits middle cart 152 to be nested with forward nested cart 154, without leg 140 restricting the nesting action by avoiding contact with rack 160 (FIG. 8) of cart 154. Similarly, rearward nested cart 150 can nest with middle nested cart 152 while avoiding interference between rack 160 of middle nested cart 152 leg 140 of rearward nested cart 150, since the lower connection point of leg 140 is spaced away from a front edge of rearward nested cart 150.

Leg 140 is shaped to have a slanted or tapered portion near an upward end of leg 140 to also accommodate nesting of carts 150, 152 and 154. The sloped portion of leg 140 permits member 120 on forwardly nested cart 154, for example, to be accommodated by middle nested cart 152 without interference by leg 140, due to the slanted portion of leg 140 extending underneath member 120 when middle and forwardly nested carts 152, 154 are nested.

In accordance with the present disclosure, cart 100 thus provides a transportation device for transporting large area objects, as illustrated in FIG. 9, through the use of a support in the form of leg 140, while permitting cart 100 to be nestable with like carts 100. At the same time, cart 100 permits more conventionally shaped objects or containers to be accommodated for transport in a shopping environment, for example, where cart 100 can be easily manipulated by the user/shopper. Cart 100 thus provides the advantages of easily transporting large area objects that are well supported by cart 100, while permitting more conventional merchandise to also be transported, and while permitting cart 100 to be nestable.

It should be emphasized that the above-described embodiments of the present invention are just possible examples of implementations, merely set forth for a clear understanding of the principles of the invention. Many variations and modifications may be made to the above-described embodiments of the invention without departing from the spirit and principles of the invention. All such modifications and variations are intended to be included herein within the scope of this disclosure and the present invention and protected by the following claims.

What is claimed is:

1. A wheeled cart for transporting a large area object, comprising:
a frame that includes a deck portion and an upright portion;
a central leg coupled to the deck portion at a location being spaced from a front edge and toward one side of the deck and being coupled to the upright portion to form a smaller dimensional area partially defined by the upright portion, one side of the central leg and the lower deck in relation to a larger dimensional area partially defined by the upright portion, another side of the central leg and the lower deck; and
the shape and arrangement of the central leg contributing to support for a large area object located in the smaller dimensional area and permitting the cart to nest with other like carts.

2. The cart according to claim 1, further comprising a crossbar attached to the deck, the central leg being coupled to the crossbar.

3. The cart according to claim 1, further comprising a support member connected to the upper portion, the central leg being coupled to the support member.

4. The cart according to claim 1, wherein the central leg further comprises a slanted portion near an upper end of the central leg to accommodate nesting operation.

5. The cart according to claim 3, further comprising a bracket located on one or more of the central leg, upright portion or support member for supporting a container.

6. The cart according to claim 1, wherein the deck further comprises a hinged rack being operable to pivot in a nesting operation.

7. A wheeled cart for transporting a large area object, comprising:
a generally horizontal deck for supporting objects and including a front edge, a rear edge and a side edge;
a generally vertical post coupled to the deck near the side edge and the rear edge;
a divider coupled to the deck at a location rearward of the front edge to divide the deck into at least two unequal regions and extending rearward of at least a portion of the post such that a smaller one of the at least two unequal regions is defined by the deck, the post and the divider; and
the divider being shaped and configured to avoid interference with other like carts upon being nested.

8. The cart according to claim 7, further comprising a crossbar attached to the deck, the divider being attached to the crossbar.

9. The cart according to claim 7, further comprising a support member connected between the post and the divider.

10. The cart according to claim 7, wherein the divider further comprises a slanted portion near an upper end of the divider to accommodate nesting operation.

11. The cart according to claim 9, further comprising a bracket located on one or more of the divider or support member for supporting a container.

12. The cart according to claim 1, wherein the deck further comprises a hinged rack being operable to pivot in a nesting operation.

13. A method for transporting a large area object with a wheeled cart, comprising:
providing a generally horizontal deck to the cart for supporting objects and including a front edge, a rear edge and a side edge;
providing a generally vertical post coupled to the deck near the side edge and the rear edge;
providing a divider coupled to the deck at a location rearward of the front edge to divide the deck into at least two unequal regions and extending rearward of at least a portion of the post such that a smaller one of the at least two unequal regions is defined by the deck, the post and the divider; and
configuring the divider to avoid interference with other like carts upon being nested.
